(19) United States
(12) Patent Application Publication
(10) Pub. No.: US 2016/0349847 A1
(43) Pub. Date: Dec. 1, 2016

(54) ELECTRONIC DEVICE, INPUT APPARATUS, AND DRIVE CONTROLLING METHOD

(71) Applicant: FUJITSU LIMITED, Kawasaki-Shi (JP)

(72) Inventors: Yohei SUGIURA, Kawasaki (JP); Nobutoshi KUMAGAI, Kawasaki (JP); Arata JOGO, Kawasaki (JP); Makoto SAOTOME, Kawasaki (JP); Yasuhiro ENDO, Ebina (JP); Yuichi KAMATA, lsehara (JP); Kiyoshi TANINAKA, Ebina (JP); Akinori MIYAMOTO, Sagamihara (JP)

(73) Assignee: FUJITSU LIMITED, Kawasaki-Shi (JP)

(21) Appl. No.: 15/233,395

(22) Filed: Aug. 10, 2016

Related U.S. Application Data
(63) Continuation of application No. PCT/JP2014/053415, filed on Feb. 14, 2014.

(51) Int. Cl. G06F 3/01; G06F 3/02; G09G 5/34; G06F 3/0354

(52) U.S. Cl. CPC G06F 3/016; G06F 3/03547; G06F 3/0227; G06F 3/03544; G09G 5/34

(57) ABSTRACT

An electronic device includes an input apparatus including a smooth manipulation surface that receives a contact manipulation separately from a display part, one or more different functions being allocated to one or more respective areas on the manipulation surface; and a drive controlling part configured to generate a natural vibration in an ultrasound frequency band with an amplitude or a vibration pattern that differs in accordance with the one or more areas where the contact manipulation is performed.

### CROSS-REFERENCE TO RELATED APPLICATION

This application is a continuation application of International Application PCT/JP2014/053415 filed on Feb. 14, 2014 and designated the U.S., the entire contents of which are incorporated herein by reference.

### FIELD

The embodiment discussed herein relates to an electronic device, an input apparatus, and a drive controlling method of an electronic device.

### BACKGROUND

An input apparatus (such as a keyboard, a mouse, a touch pad, and a digitizer pen) of a conventional personal computer (PC) has various physical keys for performing an input, and the input is performed by pushing the key. However, recently, touch panels have been spread in a field of the PC. Accordingly, the touch panel or the touch panel and buttons or the like arranged under the touch panel are also used in the input apparatus in many cases instead of the physical keys or buttons.

For example, a notebook PC having a configuration in which a pointing device (referred to as “touch pad” hereinafter) is arranged on the near side of a keyboard is known in the related art. The pointing device is configured with the touch panel and a plurality of buttons. Recently, a notebook PC having a pointing device (referred to as “click pad” hereinafter) has become popular. In the click pad, a button is arranged under a touch panel surface. When a specific area on the touch panel of the click pad is pushed, a left click or a right click is realized. Because the click pad can have an area for the touch panel wider than the touch pad, a multi-touch operation, which has been performed in a recent PC, can be easily performed. Further, desiginability improves because it becomes a flat design.

A tactile sensation presenting apparatus is known in the related art that generates a designated tactile vibration that gives a tactile sensation to a manipulation portion when a user contacts a display part to perform a manipulation (for example, see Patent Document 1). The tactile sensation presenting apparatus generates the vibration in the contacted portion on the display part. However, the tactile sensation presenting apparatus cannot give a different tactile sensation to the user in accordance with the manipulated portion.

Because the click pad has the button under the flat pad surface, it is difficult to grasp where a clickable area is in a case where the user performs a manipulation while looking at a screen. Thus, a method for printing the clickable area on the click pad or a method for forming a concavity and convexity on the click pad can be considered to indicate the clickable area to the user. However, the printing or the formation of the concavity and convexity has a disadvantage in the designability. Further, in the former case, the user cannot discriminate the area when the user does not look at the pad. In the latter case, the concavity and convexity get in the way of a drag operation because the concavity and convexity are always present in a specific area when the touch pad is used.

As another example, an input apparatus that includes a mouse having a smooth surface in order to improve the designability is known in the related art. The mouse has a design where it is difficult to grasp where a button is. In this kind of mouse, a button operation of the mouse is realized by using the touch panel to detect a finger touching a housing. However, it is difficult for the user to recognize where the button is and what kind of function the button has.

### RELATED-ART DOCUMENTS

### Patent Documents

[Patent Document 1] Japanese Laid-open Patent Publication No. 2010-231609

### SUMMARY

According to an aspect of the embodiments, an electronic device includes an input apparatus including a smooth manipulation surface that receives a contact manipulation separately from a display part, one or more different functions being allocated to one or more respective areas on the manipulation surface; and a drive controlling part configured to generate a natural vibration in an ultrasound frequency band with an amplitude or a vibration pattern that differs in accordance with the one or more areas where the contact manipulation is performed.

### BRIEF DESCRIPTION OF DRAWINGS

FIG. 1 is a perspective view illustrating an example of an input apparatus according to an embodiment;

FIG. 2 is a plan view of the input apparatus;

FIG. 3 is a diagram illustrating a cross-sectional view of the input apparatus taken along a line A-A of FIG. 2;

FIG. 4A is a diagram illustrating a standing wave generated in a top panel by a natural vibration in an ultrasound frequency band;

FIG. 4B is a diagram illustrating the standing wave generated in the top panel by the natural vibration in the ultrasound frequency band;

FIG. 5A is a diagram illustrating a case where a kinetic friction force applied to a fingertip performing a manipulation input varies in accordance with presence/absence of the natural vibration in the ultrasound frequency band generated in the top panel;

FIG. 5B is a diagram illustrating a case where the kinetic friction force applied to the fingertip performing the manipulation input varies in accordance with presence/absence of the natural vibration in the ultrasound frequency band generated in the top panel;

FIG. 6 is a diagram illustrating a configuration of the input apparatus and an electronic device using the input apparatus according to the embodiment;

FIG. 7A is a diagram illustrating first data stored in a memory;

FIG. 7B is a diagram illustrating second data stored in the memory;

FIG. 8 is a flowchart illustrating processing executed by a drive controlling part of the electronic device according to the embodiment;

FIG. 9 is a diagram illustrating an example of a contact manipulation on the input apparatus according to the embodiment;

FIG. 10 is a diagram illustrating a driving signal corresponding to the contact manipulation in FIG. 9;

FIG. 11 is a diagram illustrating an example of a contact manipulation on the input apparatus according to the embodiment;

FIG. 12 is a diagram illustrating a driving signal corresponding to the contact manipulation in FIG. 11; and

FIGS. 13A to 13C are diagrams illustrating examples of application to other input apparatuses.

### DESCRIPTION OF EMBODIMENT

In the following, an input apparatus and an electronic device using the input apparatus according to an embodiment of the present invention are described. In the embodiment, where a function button is in an input apparatus including a smooth surface and what kind of function the function button has are presented to a user with tactile sensations.

For example, in a case of using a click pad, tactile sensations of the click pad are varied to notify the user of presence in or entrance into an area where a right click can be performed on the click pad. A variation of the tactile sensations can be realized by generating vibrations at a natural vibration frequency of the click pad and by varying an amplitude or a vibration pattern of the vibrations. In this way, the user can discriminate one or more areas where a contact manipulation can be performed without looking at the pad. Here, an input apparatus of the embodiment is an input apparatus provided separately and independently from a display apparatus such as a liquid crystal panel.

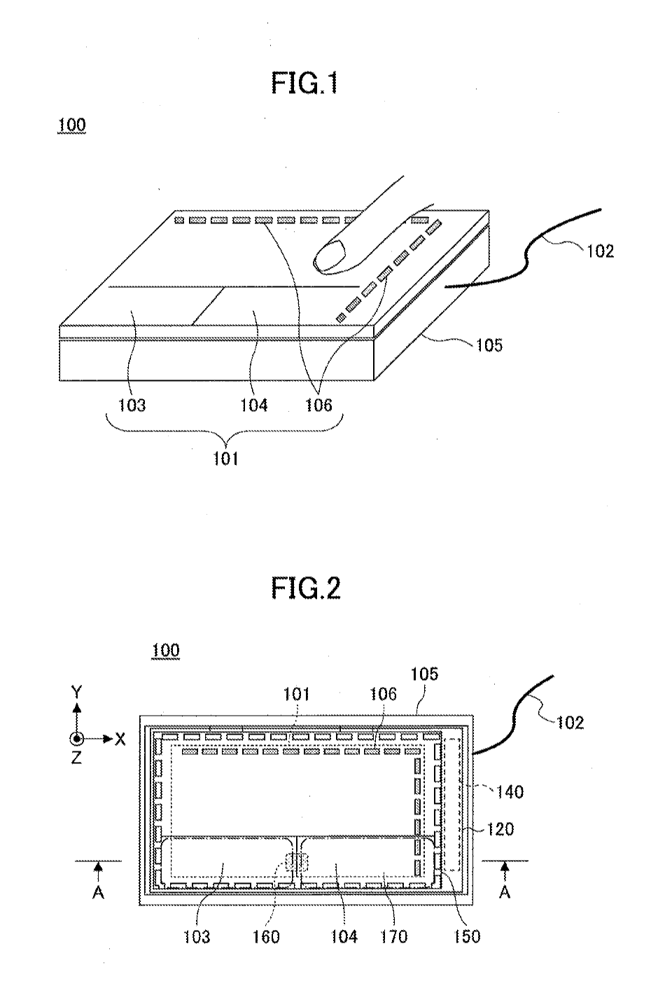

FIG. 1 illustrates a click pad 100 as an example of an input apparatus 100. The input apparatus 100 may be a device that has a smooth surface, which the user can touch, and a sensor that can detect coordinates of a contact position. Accordingly, instead of the click pad 100, the input apparatus 100 may be a keyboard or a mouse where a touch sensor is arranged under a manipulation surface. Here, the “smooth surface” does not have a dent or a concavity and convexity for zoning a button, an area, or the like to which a function is allocated. In the “smooth surface”, a boundary of the function area is not clearly indicated.

Depending on positions to be contacted and touching manners, different functions are allocated to an input manipulation part 101. For example, tapping or pressing an area 103 corresponds to a left click of the mouse. Tapping or pressing an area 104 corresponds to a right click of the mouse. Further, an area 106 for scrolling is arranged along a short side and a long side of the input manipulation part 101. The user contacts and manipulates the input manipulation part 101 with the finger(s) or the like to perform a desired input.

The “smooth surface” of the input manipulation part 101 is in a state where the dent, the concavity and convexity, or the like for zoning the area or the function button is not formed. Although the areas 103, 104, 106, and the like are illustrated by solid lines in FIG. 1 for convenience of description, boundary lines as illustrated in FIG. 1 do not have to be formed on the surface of the actual click pad 100.

An input result according to the contact manipulation is transmitted to an electronic device (not illustrated) such as a personal computer (PC) via a wire 102. A result in accordance with the input content is received from the electronic device.

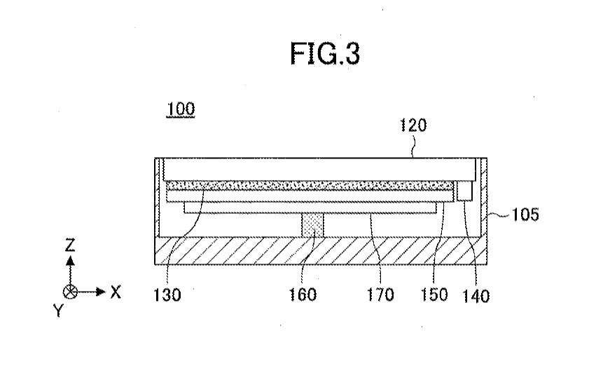

FIG. 2 is a plan view of the input apparatus. FIG. 3 is a cross-sectional view of the input apparatus taken along a line A-A of FIG. 2. The click pad 100 includes the input manipulation part 101 on a housing 105. The wire 102 is connected to a substrate 170 inside of the housing 105. As described above, the wire 102 connects the input apparatus 100 to the external electronic device (such as the PC).

A touch panel 150 is arranged on a back face of the manipulation surface via an adhesive material 130. The touch panel 150 can detect contact with the manipulation surface. Depending on areas, various functions are allocated to the input manipulation part 101 by control software. As illustrated in FIG. 1, the area 103 corresponding to the left button, the area 104 corresponding to the right button, and the area 106 for scrolling are provided in the input manipulation part 101.

The click pad 100 includes a top panel 120, a vibrating element 140, the touch panel 150, a button 160, and the substrate 170 disposed inside of the housing 105. In this example, the top panel 120 is a thin plate-shaped member. A planar shape of the top panel 120 is a rectangular shape. A material of the top panel 120 is an arbitrary material that can use the touch panel to detect coordinates of a finger touching the top panel 120 and can be driven at a natural vibration frequency in an ultrasound frequency band. In a case where a capacitance type touch panel is used as the touch panel 150, the top panel 120 is made of a transparent glass or a reinforced plastic such as polycarbonate. The vibrating element 140 is arranged on a back face (face on negative side in z axis direction) of the top panel 120. Another panel, a protection film, or the like may be provided on the surface of the top panel 120 as long as the top panel 120 protects the surface of the touch panel 150 and does not disturb the contact detection by the touch panel 150 and driving by the ultrasound wave.

The top panel 120 vibrates when the vibrating element 140 is driven. In the embodiment, a standing wave is generated in the top panel 120 by causing the top panel 120 to vibrate at a natural resonance frequency of the top panel 120. The natural resonance frequency of the top panel 120 is determined in consideration of a weight of the vibrating element 140 bonded on the top panel 120 or the like.

The vibrating element 140 may be any element as long as it can generate vibration in an ultrasound frequency band. An element including a piezoelectric element such as a piezo element may be used as the vibrating element 140, for example. The vibrating element 140 is driven by a driving signal output from a drive controlling part which will be described later. A frequency and an amplitude (intensity) of the vibration generated by the vibrating element 140 are set by the driving signal. An on/off action of the vibrating element 140 is controlled by the driving signal.

The ultrasound frequency band is a frequency band which is higher than or equal to about 20 kHz, for example. According to the click pad 100 of the embodiment, the frequency at which the vibrating element 140 vibrates is equal to a number of vibrations per unit time (frequency) of the top panel 120. Accordingly, the vibrating element 140 is driven in accordance with the driving signal so that the vibrating element 140 vibrates at a number of natural vibrations per unit time (natural vibration frequency) of the top panel 120. Different tactile sensations can be given by varying the amplitude (intensity) or the vibration pattern while maintain the vibration frequency.

The touch panel 150 may be a coordinate detector that can detect a contact position of the user on the top panel 120. The touch panel 150 may be a capacitance type coordinate detector or a resistance film type coordinate detector, for example. Alternatively, a coordinate detector using a camera, or an optical touch panel may be used. In the latter case, the touch panel 150 is arranged above the top panel 120. Hereinafter, the capacitance type coordinate detector is used as the touch panel 150. In a case where the touch panel 150 is a capacitance type, the touch panel 150 can detect a manipulation input performed on the top panel 120 even if there is a clearance gap between the touch panel 150 and the top panel 120.

The substrate 170 is disposed inside of the housing 105 via holders 108 and the button 160. The touch panel 150 and the top panel 120 are arranged on the substrate 170. The button 160 is arranged below the substrate 170 as a dome switch, for example. When the top panel 120 is pushed, the substrate 170, the touch panel 150, and the top panel 120 are bent about the holders 108. When a distance to a bottom face of the housing 105 is reduced, an input determination is performed depending on the button push. On the substrate 170, a drive controlling apparatus which will be described hereinafter and various circuits or the like that are necessary for driving the click pad 100 are mounted.

In the click pad 100 having the configuration as described above, when the user touches the top panel 120 with the finger and a position or a movement of the fingertip is detected, a drive controlling part mounted on the substrate 170 drives the vibrating element 140 to vibrate the top panel 120 at a frequency in the ultrasound frequency band. The frequency at the ultrasound frequency band is a resonance frequency of a resonance system including the top panel 120 and the vibrating element 140. A standing wave is generated in the top panel 120 at the frequency.

Vibrations having different patterns are generated in the top panel 120 in accordance with movements of a contact portion or a contact position of the user on the top panel 120. Thereby, it becomes possible to allow the user to recognize, with tactile sensations, which function button is manipulated.

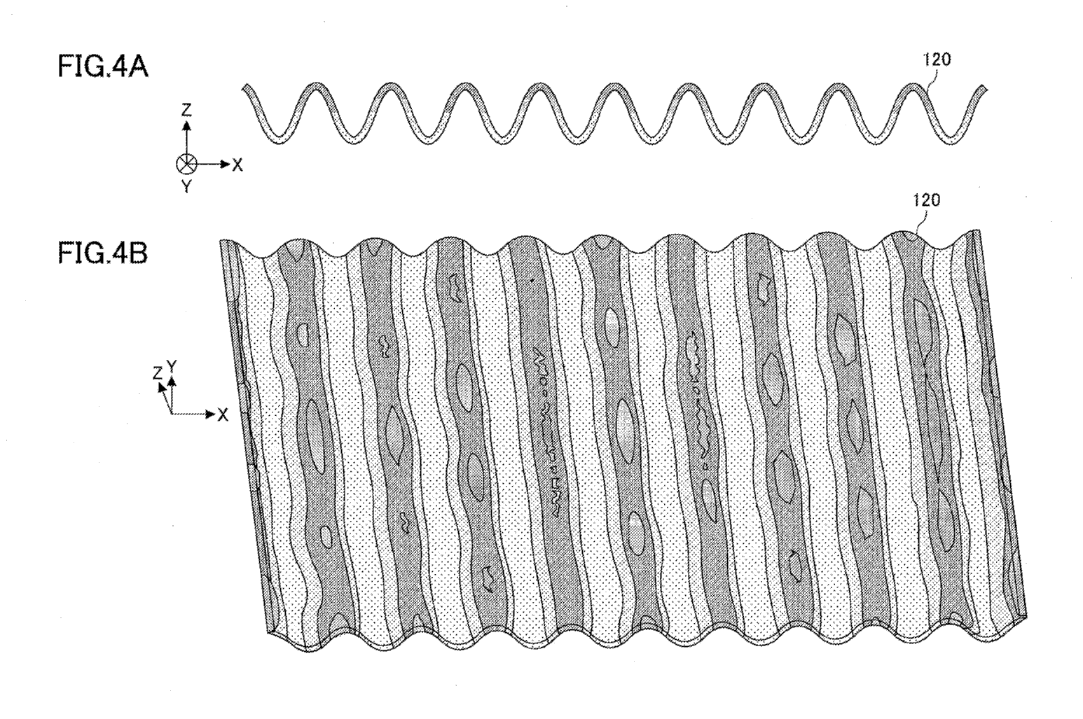

FIGS. 4A and 4B are diagrams that describe the standing wave generated in the top panel 120. In FIGS. 4A and 4B, the standing wave forming crests of the wave in parallel with the short side of the top panel 120 is generated by the natural vibration in the ultrasound frequency band. FIG. 4A illustrates a side view, and FIG. 4B illustrates a perspective view. In FIGS. 4A and 4B, a XYZ coordinate system similar to that described in FIGS. 2 and 3 is defined.

The natural vibration frequency (the resonance frequency) f of the top panel 120 is represented by formulas (1) and (2) where E is the Young's modulus of the top panel 120, ρ is the density of the top panel 120, δ is the Poisson's ratio of the top panel 120, l is the long side dimension of the top panel 120, t is the thickness of the top panel 120, and k is a periodic number of the standing wave along the direction of the long side of the top panel 120.

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

Because the standing wave has the same waveforms in every half cycle, the periodic number k takes values at 0.5 intervals. The periodic number k takes 0.5, 1, 1.5, 2 . . . . The coefficient α included in formula (2) corresponds to coefficients other than k² included in formula (1).

A waveform of the standing wave as illustrated in FIGS. 4A and 4B is obtained in a case where the periodic number k is 10, for example. In a case where a sheet of Gorilla (registered trademark) glass of which the length l of the long side is 140 mm, the length of the short side is 80 mm, and the thickness t is 0.7 mm is used as the top panel 120, for example, the natural vibration number f is 33.5 kHz, if the periodic number k is 10. In this case, a frequency of the driving signal is 33.5 kHz.

The top panel 120 is a flat member. If the vibrating element 140 (see FIGS. 2 and 3) is driven and the natural vibration in the ultrasound frequency band is generated in the top panel 120, the top panel 120 is bent as illustrated in FIGS. 4A and 4B. As a result, the standing wave is generated in the surface of the top panel 120.

Although an example of a configuration is described as illustrated in FIG. 2 in which the single vibrating element 140 is arranged, on the back face (a negative side face in z axis direction) of the top panel 120, along one of the short sides (y axis direction), two vibrating elements 140 may be used. In a case where the two vibrating elements 140 are used, another vibrating element 140 may be bonded along the other of the short sides of the top panel 120. In this case, the two vibrating elements 140 may be axisymmetrically disposed with respect to a center line of the top panel 120 parallel to the two short sides of the top panel 120. In a case where the two vibrating elements 140 are driven, the two vibrating elements 140 may be driven in the same phase, if the periodic number k is an integer number. If the periodic number k is an odd number, the two vibrating elements 140 may be driven in opposite phases.

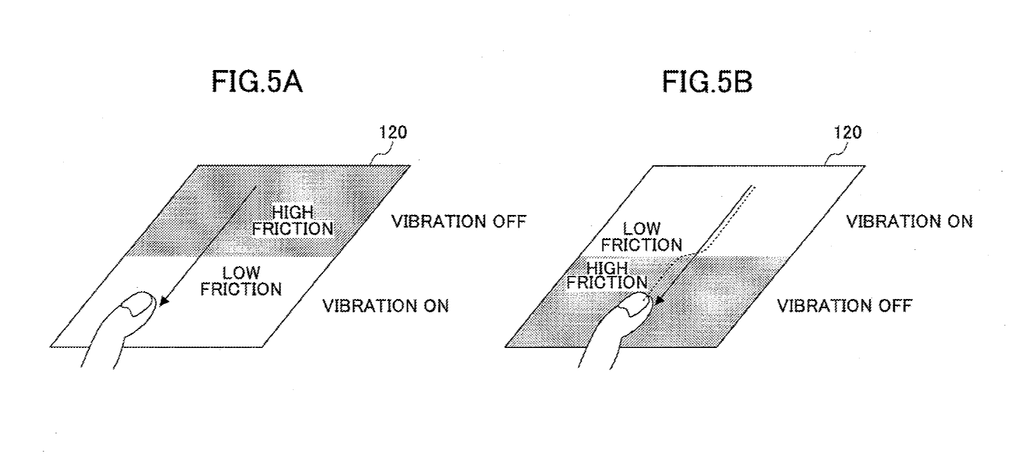

FIGS. 5A and 5B are diagrams describing effects of the natural vibration in the ultrasound frequency band generated in the top panel 120 of the click pad 100. When the natural vibration in the ultrasound frequency band is generated or stopped in the top panel 120 of the click pad 100, a kinetic friction force applied to the fingertip of the user, who performs the manipulation input, varies.

In FIGS. 5A and 5B, the user moves the finger in a direction of the arrow to perform a manipulation or an input while touching the top panel 120 with the fingertip. An on/off state of the vibration during movement of the user's finger is switched by switching an on/off state of the vibrating element 140 (see FIGS. 2 and 3). In FIGS. 5A and 5B, areas which the finger touches while the vibration is turned off are indicated in grey and areas which the finger touches while the vibration is turned on are indicated in white.

In the operation pattern illustrated in FIG. 5A, the vibration is turned off when the user's finger is located on the far side of the top panel 120, and the vibration is turned on in the process of moving the finger toward the near side. In the operation pattern illustrated in FIG. 5B, the vibration is turned on when the user's finger is located on the far side of the top panel 120, and the vibration is turned off in the process of moving the finger toward the near side.

When the natural vibration in the ultrasound frequency band is generated in the top panel 120, a layer of air intervenes between the surface of the top panel 120 and the finger. The layer of air is provided by a squeeze film effect. As a result, a kinetic friction coefficient when the user traces the surface of the top panel 120 with the finger is decreased. Accordingly, in the grey area located on the far side of the top panel 120 illustrated in FIG. 5A, the kinetic friction force applied to the fingertip increases. In the white area located on the near side of the top panel 120, the kinetic friction force applied to the fingertip decreases.

The user who is performing the manipulation input in a direction of the arrow illustrated in FIG. 5A senses a reduction of the kinetic friction force applied to the fingertip when the vibration is turned on. As a result, the user senses slipperiness with the fingertip. In this case, the user feels as if a concave portion were present on the surface of the top panel 120 when the surface of the top panel 120 becomes slippery and the kinetic friction force decreases.

In FIG. 5B, the kinetic friction force applied to the fingertip decreases in the white area located on the far side of the top panel 120, and the kinetic friction force applied to the fingertip increases in the grey area located on the near side of the top panel 120. The user who is performing the manipulation input in a direction of the arrow illustrated in FIG. 5B senses an increase of the kinetic friction force applied to the fingertip when the vibration is turned off. As a result, the user senses a grippy or scratchy touch (texture) with the fingertip. In this case, the user senses as if a convex portion were present on the surface of the top panel 120 when the fingertip becomes grippy and the kinetic friction force increases.

According to the above described configuration, the user can sense a concavity or convexity with the fingertip in the cases as illustrated in FIGS. 5A and 5B. For example, “The Printed-matter Typecasting Method for Haptic Feel Design and Sticky-band Illusion” (the Collection of papers of the 11th SICE system integration division annual conference (SI2010, Sendai)_174-177, 2010-12) discloses that a human can sense a concavity or a convexity. “Fishbone Tactile Illusion” (Collection of papers of the 10th Congress of the Virtual Reality Society of Japan (September, 2005)) discloses that a human can sense a concavity or a convexity as well.

Although a variation of the kinetic friction force when the on/off of the vibration is switched is described in the above described examples, similar effects are obtained when the amplitude (intensity) of the vibrating element 140 is varied. For example, strength of the amplitude of the natural vibration in the ultrasound frequency band may be continuously varied in a specific area on the manipulation surface of the click pad 100 to generate a scroll feeling.

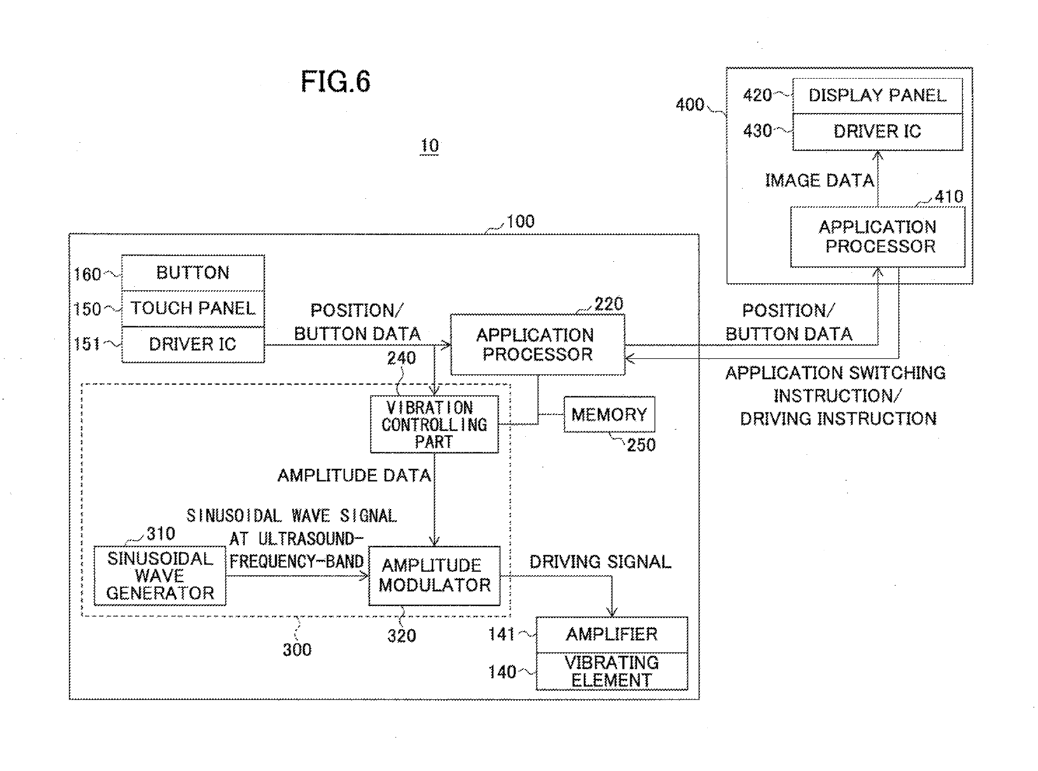

FIG. 6 is a block diagram illustrating a configuration of the input apparatus (click pad, for example) 100 and the electronic device 10 using the input apparatus 100. The input apparatus 100 is connected to a PC body 400 and becomes a part of the electronic device 10 such as a personal computer (PC). The PC body 400 includes an application processor 410, a display panel 420, and a driver Integrated Circuit (IC) 430.

The input apparatus 100 includes the vibrating element 140, an amplifier 141, the touch panel 150, a driver Integrated Circuit (IC) 151, the button 160, an application processor 220, a memory 250, and a drive controlling apparatus 300. The drive controlling apparatus 300 includes a sinusoidal wave generator 310, an amplitude modulator 320, and a vibration controlling part 240. The application processor 220 of the input apparatus 100 is connected to the application processor 410 of the PC body 400 by radio or a wire. In FIG. 6, the holders 108, the housing 105, the top panel 120, and the like of the input apparatus 100 (see FIGS. 2 and 3) are omitted. Among elements of the input apparatus 100, the drive controlling apparatus 300, the application processor 220, and the memory 250 may be arranged in the PC body 400. Further, the amplifier 141 and the driver IC 151 may also be arranged in the PC body 400.

The amplifier 141 is disposed between the drive controlling apparatus 300 and the vibrating element 140. The amplifier 141 amplifies the driving signal output from the drive controlling apparatus 300 and drives the vibrating element 140. The driver IC 151 is connected to the touch panel 150 and the button 160. The driver IC 151 detects position data representing the position on the touch panel 150 where the manipulation input is performed. The detected position data is output to the controlling part 200. In a case where an input to the button 160 is present, the driver IC 151 uses the position data detected by the touch panel to determine which area is manipulated in the input manipulation part 101 (see FIG. 1) and to determine whether the button input is performed. The driver IC151 outputs a determination result to the controlling part 200. These position data are input to the application processor 220 and the vibration controlling part 240. Inputting the position data to the vibration controlling part 240 is equal to inputting the position data to the drive controlling apparatus 300.

The vibration controlling part 240 outputs, to the amplitude modulator 320, amplitude data that differs in accordance with the position data. The amplitude data represents an amplitude value for controlling an intensity of the driving signal used to drive the vibrating element 140. The amplitude value is set in accordance with the position or a temporal change degree of the position.

The drive controlling apparatus 300 outputs the amplitude data to the amplitude modulator 320 in a case where the position of the fingertip performing the manipulation input is within a designated area which requires generating a specific vibration. The drive controlling apparatus 300 determines whether the position of the fingertip performing the manipulation input is within the designated area which requires generating the vibration based on the position information on the fingertip performing the manipulation input. In the embodiment, the top panel 120 is vibrated in order to vary the kinetic friction force applied to the fingertip when a specific operation is performed on the surface of the top panel 120 in addition to a case where the user's fingertip moves to or is located in a specific area on the surface of the top panel 120.

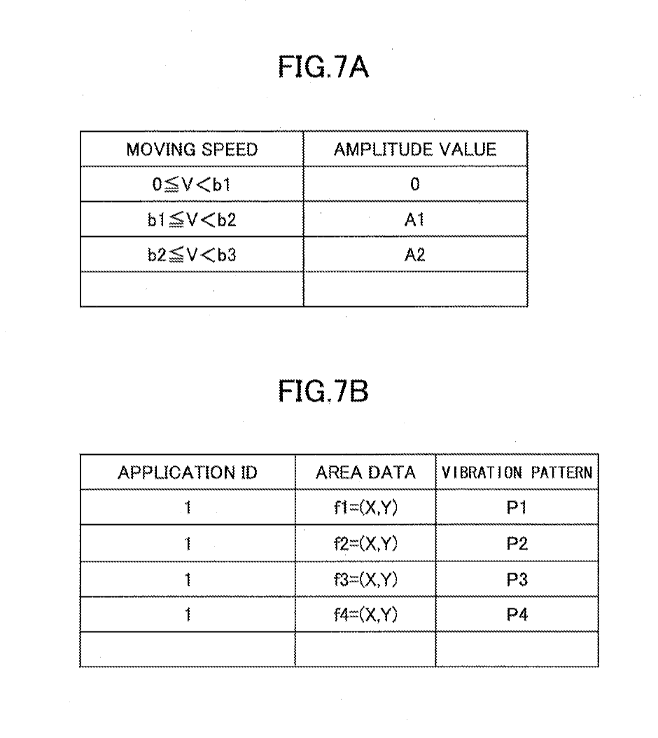

As examples of the input manipulation, there is an operation to push down the area 103 (left click area) or the area 104 (right click area) on the input manipulation part 101, and an operation to move the fingertip along the area 106 for scrolling. Further, there is a flick operation to flick the surface of the input manipulation part 101 (that is, the top panel 120) with the fingertip and a swipe operation to move the fingertip on the surface of the top panel 120 as if to turn a page. As illustrated in FIG. 7A, first data that associates the moving speed of the finger with the amplitude value is stored in the memory 250. Thereby, it becomes possible to present the same tactile sensations to the user even when the moving speed of the finger changes within the same area. Further, the vibration can be stopped (amplitude value zero) in a case where the movement is very small or becomes almost zero.

Because the functions (applications) that are different in accordance with the areas are allocated on the input manipulation part 101, a kind of applications allocated to the input manipulation part 101 is related when it is determined whether the contact manipulation position is within the specific area. Further, the flick operation, the swipe operation, or the like is differently used depending on the kind of applications. In this meaning, it is preferable to store second data in the memory 250 as illustrated in FIG. 7B. The second data associates the area data, representing the area where the manipulation input is performed, and the vibration pattern P with the kind of applications.

The vibration controlling part 240 uses the area data (first data or second data) in the memory 250 to determine whether the position represented by the position data supplied from the driver IC 151 is located in the designated area which requires generating the vibration. When determining whether the position is located in the designated area, the vibration controlling part 240 calculates a direction and a positional change (vector) of the fingertip to estimate a coordinate point after a lapse of a period of time Δt. The period of time Δt is equal to a period of time corresponding to one cycle of the control of the PC body 400, for example. When the position after the lapse of the period of time Δt has been estimated, the vibration controlling part 240 determines, with reference to the memory 250, whether the estimated position is located in the specific area that requires generating the vibration. In a case where the estimated position is located in the area that requires generating the vibration, the vibration controlling part 240 outputs, to the amplitude modulator 320, the amplitude data representing the vibration pattern or the amplitude value of the natural vibration of the input manipulation part 101.

The sinusoidal wave generator 310 generates sinusoidal waves used for generating the driving signal which causes the top panel 120 to vibrate at the natural vibration frequency. For example, in a case of causing the top panel 120 to vibrate at 33.5 kHz of the natural vibration frequency f, a frequency of the sinusoidal waves becomes 33.5 kHz. The sinusoidal wave generator 310 inputs a sinusoidal wave signal in the ultrasound frequency band to the amplitude modulator 320.

The amplitude modulator 320 generates the driving signal by modulating an amplitude of the sinusoidal wave signal input from the sinusoidal wave generator 310 based on the amplitude data input from the vibration controlling part 240. The amplitude modulator 320 modulates only the amplitude of the sinusoidal wave signal in the ultrasound frequency band input from the sinusoidal wave generator 310. In other words, the amplitude modulator 320 generates the driving signal without modulating a frequency and a phase of the sinusoidal wave signal. In a case where the amplitude data is zero, the amplitude of the driving signal becomes zero. This is the same as the amplitude modulator 320 not outputting the driving signal.

FIG. 7A illustrates an example of the first data stored in the memory 250. FIG. 7B illustrates an example of the second data stored in the memory 250. In FIG. 7A, different amplitude values (0, A1, A2) are set in accordance with the moving speed V of the finger. In FIG. 7B, the application ID (Identification) is illustrated as the data representing the kind of the application. The coordinate values (f1 to f4) on the top panel 120 where the contact manipulation is performed are stored as associated area data. P1 to P4 are stored as the vibration patterns associated with the area data. Instead of the first data in FIG. 7A, formula (3) representing the amplitude A as a function of the moving speed V may be stored in the memory 250.

A=A₀/\sqrt{|V|/a} (3)

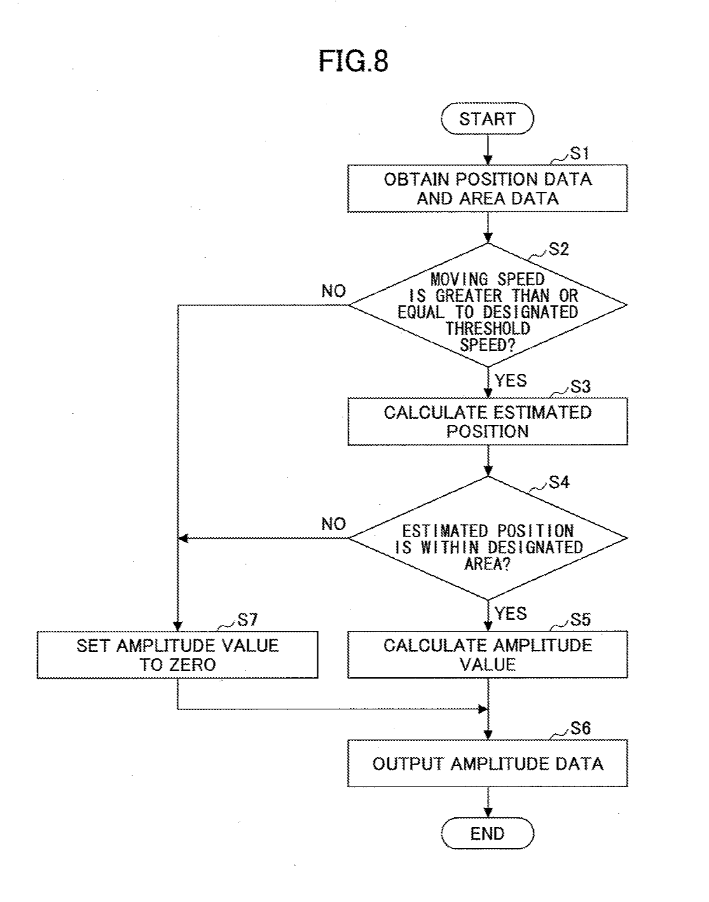

FIG. 8 is a flowchart of processing executed by the vibration controlling part 240 of the drive controlling apparatus 300. Firmware (FW) or an operating system (OS) of the PC body 400 executes control for driving the electronic device 10 with respect to every designated control cycle. Thus, the vibration controlling part 240 of the drive controlling apparatus 300 repeatedly executes the processing flow of FIG. 8 in the designated control cycle.

A period of time of one cycle of the control cycle can be treated as the required period of time Δt which is required from the point in time when the position data is input to the drive control apparatus 300 from the driver IC 151 to the point in time when the driving signal is calculated based on the input position data.

The vibration controlling part 240 starts the processing when the electronic device 10 is turned on. The vibration controlling part 240 obtains current position data and area data (step S1). The area data is obtained with respect to a function or an application allocated to a specific area on the input manipulation part 101 in accordance with the coordinates represented by the position data. The area data is associated with the vibration pattern as illustrated in FIG. 7B.

The vibration controlling part 240 determines whether the moving speed is greater than or equal to the designated threshold speed (step S2). The moving speed may be calculated by a vector operation. The threshold speed may be set as a typical minimum speed when scrolling or moving from an area, to which a function is not allocated, to the left click area or the right click area. Such a minimum speed may be set based on an experimental result, a resolution capability of the touch panel 150, or the like.

The vibration controlling part 240 calculates the estimated coordinate point after a lapse of the required period of time Δt based on the coordinate point represented by the present position data and the moving speed (step S3), in a case where the vibration controlling part 240 has determined at step S2 that the moving speed is greater than or equal to the designated threshold speed.

The vibration controlling part 240 determines at step S4 whether the estimated coordinate point after the lapse of the required period of time Δt is within an area represented by the area data calculated at step S1. In a case where the estimated coordinate point after the lapse of the required period of time Δt is within the area represented by the area data, the vibration controlling part 240 calculates the amplitude value corresponding to the moving speed calculated at step S2 from the first data of FIG. 7A (step S5).

The vibration controlling part 240 outputs the amplitude data (step S6). Thereby, the amplitude modulator 320 modulates the amplitude of the sinusoidal wave output from the sinusoidal wave generator 310 to generate the driving signal, and the vibrating element 140 is driven.

In contrast, in a case where the moving speed is not greater than or equal to the designated threshold speed (no at step S2) or in a case where the estimated coordinate point after the lapse of the required period of time Δt is not located in the area represented by the area data calculated at step S1 (no at step S4), the vibration controlling part 240 sets the amplitude value to zero (step S7).

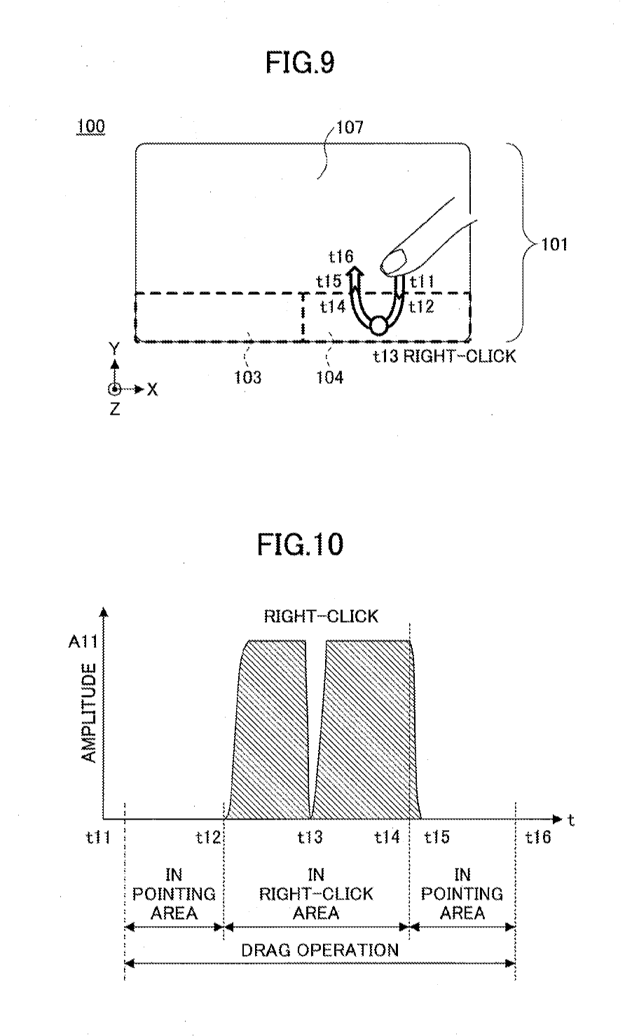

In the following, examples of a specific operation of the input apparatus 100 are described with reference to FIGS. 9 to 12. In FIGS. 9 to 12, a XYZ coordinate system similar to that described in FIGS. 2 to 4 is defined.

### Working Example 1

FIG. 9 is a diagram illustrating the input manipulation part 101 of the input apparatus 100 in plan view. In this example, the user touches an area 107 to which a pointing function is allocated in the input manipulation part 101, performs a drag operation in illustrated order from time t11 to time t15, and executes a right click at time t13 on the way.

Here, an application that allocates a function of the right click to the area 104 is used. Vibration waveform data, of which the amplitude is zero, is stored in the memory 250 in association with area information on the area 107 where a pointer is moved and manipulated. Vibration waveform data, of which the amplitude is A11, is stored in the memory 250 in association with area information on the area 104 corresponding to the right button.

Every time the vibration controlling part 240 obtains the position data from the driver IC 151, the vibration controlling part 240 determines whether a contact manipulation position of the user is located in the area 104 for the right button and determines whether the function allocated to the area 104 is selected and executed.

FIG. 10 illustrates a driving signal output from the drive controlling apparatus 300 corresponding to the manipulation in FIG. 9. The driving signal is output from the amplitude modulator 320 based on the amplitude data output from the vibration controlling part 240. In FIG. 10, a horizontal axis represents a time axis, and a vertical axis represents the amplitude value of the amplitude data. In the example in FIGS. 9 and 10, it is supposed that the moving speed of the fingertip of the drag operation until the right click is performed by the user from time t11 to time t13 and the moving speed of the fingertip when performing the drag operation after the operation at time t13 to time t16 are substantially constant.

At time t11 the user touches, with the finger, the area 107 for the pointing manipulation in the input manipulation surface (for example, the top panel 120) and moves the finger toward the area 104. At time t12, the finger crosses over a boundary between the area 107 and the area 104. The vibration controlling part 240 determines that the input manipulation of the user is a manipulation performed within the area 104 for the right button, and performs drive control with a vibration pattern corresponding to the area 104.

As illustrated in FIG. 10, the amplitude of the vibration pattern corresponding to the contact manipulation performed on the area 104 for the right button is A11. While the drag operation is performed within the area 104 for the right button, a driving pattern is used to continue the vibration at the amplitude A11.

At time t13, the finger located in the area 104 is temporarily stopped, and a function selection (such as the right click) of the right button is performed. At this time, the vibration controlling part 240 determines “NO” in the moving speed determination at step S2 in FIG. 8. That is, the vibration controlling part 240 determines that the moving speed is not greater than or equal to the threshold, and the amplitude is set to zero at step S7. Accordingly, in the vibration patterns of FIG. 10, the amplitude becomes zero at time t13. When the drag is restarted after selecting the function of the right button, the amplitude is set to A11 again.

At time t14, the contact position of the finger crosses over the boundary of the area 104 for the right button and returns to the area 107 for the pointing manipulation. Thus, the amplitude is set to zero based on set data of the memory 250. At time t15, the finger separates from the top panel 120 and the drag operation ends.

As described above, in a case where the finger enters into the area 104 for the right button in order to perform the right click, the vibration controlling part 240 outputs the amplitude data of which the amplitude is a constant value (All), for example. Thus, while the user performs the drag operation in the area 104, the kinetic friction force applied to the user's fingertip decreases and the user obtains a slipping sensation with the fingertip. The user can feel that the fingertip is located in the area for the right button and can perform the click operation.

### Working Example 2

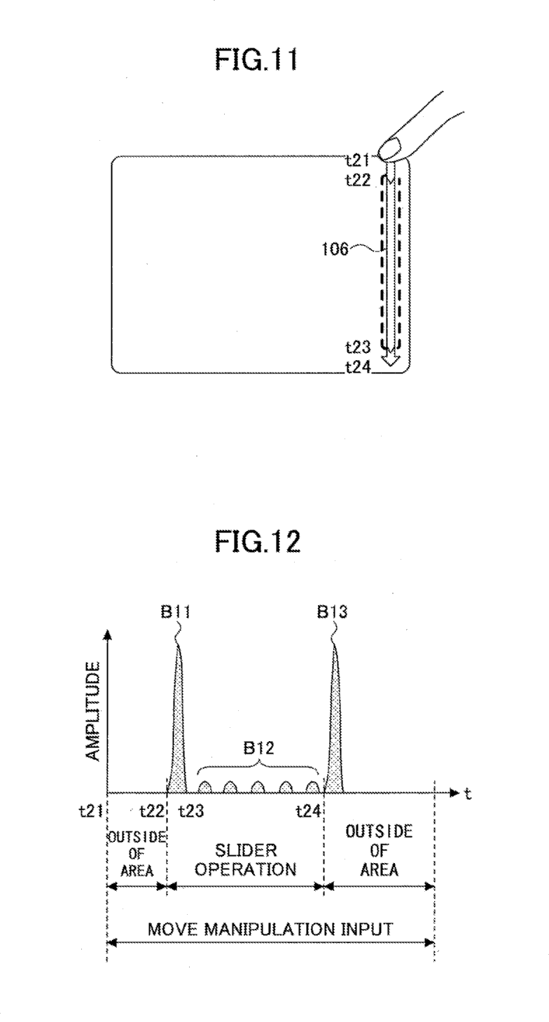

An operation of the vibration controlling part 240 in a case where the contact manipulation is performed in an operation mode for executing a slider (scrolling) function is described with reference to FIGS. 11 and 12.

As illustrated in FIG. 11, in the operation mode executing the slider function, the user's fingertip touches the top panel 120 at time t21 and enters into the area 106 for scrolling at time t22. The slider operation is performed until time t23. The fingertip separates from the top panel 120 at time t24. In this case, a vibration B11 having a great amplitude over a short amount of time occurs at time t22 when the fingertip enters into the area 106 for scrolling.

The vibration B11 provides, to the user, a tactile sensation of touching a projection with the fingertip by changing a condition from a low-friction-condition over the short amount of time, which the user may not sense with the fingertip, to a high-friction-condition instantaneously. In this way, the user can recognize that the user starts to use the slider function.

Further, when the fingertip moves, within the area 106 for scrolling, downward as illustrated by the arrow, vibrations B12 each having a small amplitude over a short amount of time occur at regular intervals. Because the vibrations are generated at the regular intervals in accordance with a scrolling amount as a wheel of the mouse, the user can feel the scrolling amount with the tactile sensations.

When the fingertip comes out of the area 106 for scrolling at time t24, a vibration B13 having a great amplitude over a short amount of time is generated. The vibration B13 is similar to the vibration B11 and provides, to the user, the tactile sensation of touching a projection with the fingertip by changing a condition from a low-friction-condition over the short amount of time, which the user may not sense with the fingertip, to a high-friction-condition instantaneously. In this way, the user can feel that the fingertip has come out of the area 106 for scrolling.

### Other Examples of Application

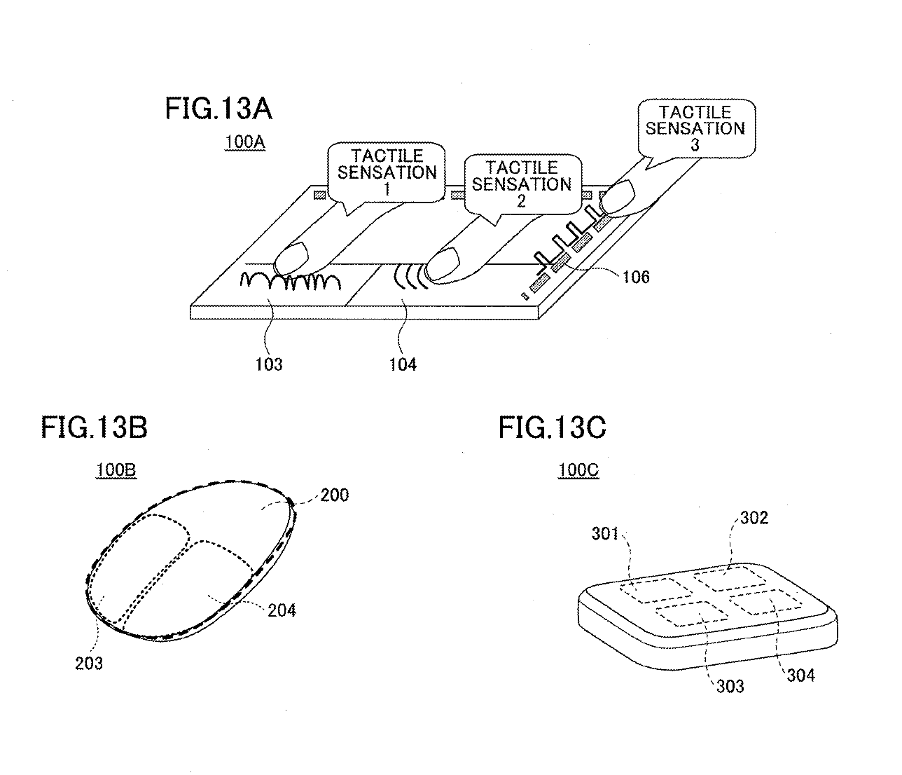

FIGS. 13A to 13C illustrate examples of application of the vibration control of the embodiment to other input apparatuses. As illustrated in FIG. 13A, respective different tactile sensations may be presented at the area 103 for the left button, the area 104 for the right button, and the area 106 for scrolling in a click pad 100A. For example, a rough tactile sensation (tactile sensation 1) is given at the area 103 and a slippery tactile sensation (tactile sensation 2) is given at the area 104. While the slider function is executed in the area 106 for scrolling, a bumpy tactile sensation (tactile sensation 3) may be given.

Further, as illustrated in FIG. 13B, the natural vibration in the ultrasound frequency band is generated with an amplitude (intensity) or a vibration that differs in an area 203 for a left button and an area 204 for a right button in a mouse 100B having a flat and smooth surface to present different tactile sensations. In this case, when the user performs the contact manipulation on an area 200 for the pointing manipulation, the mouse 100B does not have to generate the vibration.

Further, as illustrated in FIG. 13C, a flat and smooth keypad 100C may be used where a plurality of sensors 301 to 304 are arranged under the surface. In this case, the natural vibration of the keypad 100C may be generated with different amplitudes or different vibration patterns in accordance with touch operations to the respective touch sensors 301 to 304.

In the keypad 100C illustrated in FIG. 13C, area determination based on the direction of movement and the moving speed of the finger may be omitted because an objective touch sensor is tapped in a pinpoint manner and a movement to a specific area is not performed in a typical mode of using the keypad 100C. In this case, the position data and the amplitude data may be stored in the memory 250 in association with each other.

As described above, according to the above described electronic device 10 and the input apparatus 100 of the embodiment, the vibrations that differ in accordance with the manipulation position of the user and the application are generated in the surface of the input apparatus 100. Thereby, the user can recognize the manipulation being executed based on the tactile sensations.

Further, only the amplitude is modulated to generate the driving signal without modulating the frequency or the phase of the sinusoidal wave in the ultrasound frequency band generated by the sinusoidal wave generator 310. Thereby, it becomes possible to generate the natural vibration of the top panel 120 in the top panel 120. It becomes possible to reduce the kinetic friction coefficient with absolute certainty when the fingertip traces the surface of the top panel 120 by utilizing the layer of air provided by the squeeze film effect. It becomes possible to provide the fine tactile sensations to the user as if a concave portion and a convex portion were present on the surface of the top panel 120 by utilizing the Sticky-band Illusion effect or the Fishbone Tactile Illusion effect.

Further, the coordinate point after the lapse of the required period of time Δt corresponding to the period of time of one cycle of the control cycle is estimated, and the vibration is generated in a case where the estimated coordinate point is located in the designated area which requires generating the vibration. Accordingly, it becomes possible to generate the vibrations while the fingertip is actually touching the designated manipulation part or the like. In a case where a delay corresponding to the required period of time Δt, corresponding to the period of time of one cycle of the control cycle, does not matter, the calculation of the estimated position does not have to be performed.

In the embodiment, the amplitude value of the driving signal is varied between the designated amplitude value and zero to switch on/off the vibrating element in order to provide the tactile sensations to the user as if a concave portion and a convex portion were present on the top panel 120. However, instead of switching off the vibrating element 140, the amplitude may be decreased to switch the driving of the vibrating element 140. For example, the amplitude may be reduced to less than half to provide the tactile sensations to the user as if the concave portion and the convex portion were present on the top panel 120. It is preferable to reduce the amplitude to about one-fifth. In this case, the vibrating element 140 is driven by the drive signal that switches the strength of the vibration of the vibrating element 140.

According to the embodiment, it becomes possible to present the position of the function button with the tactile sensations in the input apparatus having the smooth surface.

As described above, the configurations and the methods of the present invention are described based on the specific examples. However, the present invention is not limited to these examples, but various variations and modifications may be made without departing from the scope of the present invention.

For example, although the natural vibrations are generated with vibration patterns and amplitude values corresponding to functions allocated to the respective areas on the input apparatus (click pad) 100 in the working examples, tactile sensations may be changed in accordance with the number of fingers that the user manipulates. For example, tactile sensations when manipulating with two fingers may be changed from tactile sensations when manipulating with one finger. Alternatively, tactile sensations given to the user may be changed depending on specific motions. For example, when the user performs a pinch operation on the top panel 120 with fingers, the amplitude may be increased (friction may be decreased) to give smooth tactile sensations in a stage of starting (pinch in) the operation, and heavy tactile sensations may be given by decreasing the amplitude (increasing the friction) in a pinch stage, that is, when the fingers separate from the top panel 120. In this case, the amplitude of the vibration pattern at the natural vibration frequency of the input manipulation part 101 may be varied in accordance with a time change of contact positions detected by the touch panel 150, that is, may be varied in accordance with the direction and the moving speed of the fingers.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the sprit and scope of the invention.

What is claimed is:

1. An electronic device comprising:
an input apparatus including a smooth manipulation surface that receives a contact manipulation separately from a display part, one or more different functions being allocated to one or more respective areas on the manipulation surface; and
a drive controlling part configured to generate a natural vibration in an ultrasound frequency band with an amplitude or a vibration pattern that differs in accordance with the one or more areas where the contact manipulation is performed.

2. The electronic device as claimed in claim 1, wherein the input apparatus is a touch pad arranged on a keyboard or a mouse.

3. The electronic device as claimed in claim 1, further comprising:
a sensor configured to detect a position of the contact manipulation on the manipulation surface; and
a sinusoidal wave generator configured to generate the natural vibration in the ultrasound frequency band,
wherein the drive controlling part modulates the amplitude or the vibration pattern of the natural vibration based on an output of the sensor.

4. The electronic device as claimed in claim 1,
wherein the one or more areas include an area for a pointing manipulation and an area for a specific function button, and
wherein the drive controlling part generates the natural vibration in the ultrasound frequency band with a specific amplitude or a specific vibration pattern when a position of the contact manipulation enters into the area for the function button from the area for the pointing manipulation.

5. The electronic device as claimed in claim 4,
wherein the drive controlling part maintains the natural vibration in the ultrasound frequency band at a constant amplitude value while the position of the contact manipulation moves within the area for the function button, and
wherein the drive controlling part decreases the amplitude value when a manipulation to select the function button is performed within the area for the function button.

6. The electronic device as claimed in claim 1,
wherein the one or more areas include an area for scrolling, and
wherein the drive controlling part generates the natural vibration in the ultrasound frequency band with a specific amplitude or a specific vibration pattern when a position of the contact manipulation moves along the area for scrolling.

7. The electronic device as claimed in claim 6,
wherein the drive controlling part generates the natural vibration having a first amplitude when the position of the contact manipulation enters into the area for scrolling or when the position of the contact manipulation comes out of the area for scrolling, and
wherein the drive controlling part generates the natural vibration with a second amplitude, which is smaller than the first amplitude, at regular time intervals when the position of the contact manipulation moves along the area for scrolling.

8. An input apparatus comprising:
an input manipulation part including a smooth manipulation surface that receives a contact manipulation separately from a display part; and
a vibrating element attached to the input manipulation part and configured to vibrate at a natural vibration frequency of an ultrasound frequency band of the input manipulation part,
wherein one or more different functions are allocated to one or more respective areas on the manipulation surface, and
wherein a driving signal is input to the vibrating element to generate a natural vibration in the ultrasound frequency band with an amplitude or a vibration pattern that differs in accordance with the one or more areas, where the contact manipulation is performed, to vibrate the manipulation surface.

9. The input apparatus as claimed in claim 8, wherein the input apparatus is a touch pad arranged on a keyboard or a mouse.

10. A drive controlling method of an electronic device, the drive controlling method comprising:
allocating one or more different functions to one or more respective areas on a smooth manipulation surface of an input apparatus arranged separately from a display part;
receiving a contact manipulation on the manipulation surface; and
generating a natural vibration in an ultrasound frequency band with an amplitude or a vibration pattern that differs in accordance with the one or more areas, where the contact manipulation is performed, to vibrate the manipulation surface.

11. The drive controlling method as claimed in claim 10, wherein the one or more different functions are allocated to the one or more respective areas on the manipulation surface of a touch pad on a keyboard or a mouse.

12. The drive controlling method as claimed in claim 10, further comprising:
detecting a position of the contact manipulation on the manipulation surface; and
modulating the amplitude or the vibration pattern of the natural vibration in the ultrasound frequency band based on the detected position.

13. The drive controlling method as claimed in claim 10,
wherein an area for a pointing manipulation and an area for a specific function button are allocated on the manipulation surface of the input apparatus, and
wherein the natural vibration in the ultrasound frequency band is generated with a specific amplitude or a specific vibration pattern when a position of the contact manipulation enters into the area for the function button from the area for the pointing manipulation.

14. The drive controlling method as claimed in claim 13,
wherein the natural vibration in the ultrasound frequency band is maintained at a constant amplitude value while the position of the contact manipulation moves within the area for the function button, and
wherein the amplitude value is decreased when a manipulation to select the function button is performed within the area for the function button.

15. The drive controlling method as claimed in claim 10,
wherein an area for scrolling is allocated on the manipulation surface of the input apparatus, and
wherein the natural vibration in the ultrasound frequency band is generated with a specific amplitude or a specific vibration pattern when a position of the contact manipulation moves along the area for scrolling.

16. The drive controlling method as claimed in claim 15,
wherein the natural vibration having a first amplitude is generated when the position of the contact manipulation enters into the area for scrolling or when the position of the contact manipulation comes out of the area for scrolling, and
wherein the natural vibration is generated with a second amplitude, which is smaller than the first amplitude, at regular time intervals when the position of the contact manipulation moves along the area for scrolling.
